(19) United States
(12) Patent Application Publication
(10) Pub. No.: US 2012/0303240 A1
(43) Pub. Date: Nov. 29, 2012

(54) METHOD FOR OPERATING AN INTERNAL COMBUSTION ENGINE

(75) Inventors: Cristian TAIBI, Torino (IT); Claudio MONFERRATO, Rondissone (TO) (IT)

(73) Assignee: GM GLOBAL TECHNOLOGY OPERATIONS LLC, Detroit, MI (US)

(21) Appl. No.: 13/477,272

(22) Filed: May 22, 2012

(30) Foreign Application Priority Data
May 24, 2011 (GB) 1108745.9

(51) Int. Cl. G06F 17/00

(52) U.S. Cl. 701/102

(57) ABSTRACT

A method for operating an internal combustion engine includes measuring pressure values in a combustion chamber during an engine cycle and a corresponding value of crankshaft angular position for each pressure value and selecting values from the pressure values and the corresponding value of crankshaft angular position for each selected value. The corresponding values of the crankshaft angular position are used to calculate a corresponding inner volume value of the combustion chamber for each of the selected pressure values. For each of the selected pressure values and the corresponding inner volume value, a polytrophic constant is calculated according to C=pV^{k}, C being the polytrophic constant, p the pressure value, V the inner volume value, and k the polytrophic index. A root mean square deviation (RMSD) of the polytrophic constant values is calculated and that a noise has affected the pressure values is identified if the RMSDs exceed a threshold value thereof.

### CROSS-REFERENCE TO RELATED APPLICATION

This application claims priority to British Patent Application No. 1108745.9, filed May 24, 2011, which is incorporated herein by reference in its entirety.

### TECHNICAL FIELD

The technical field generally relates to a method for operating an internal combustion engine, in particular an internal combustion engine of a motor vehicle, such as for example a diesel engine or a gasoline engine.

### BACKGROUND

Known internal combustion engines comprise an engine block including a plurality of cylinders each accommodating a reciprocating piston and closed by a cylinder head that cooperates with the piston to define a combustion chamber. The piston is mechanically coupled to a crankshaft so that a reciprocating movement of the piston is transformed into a rotation of the crankshaft and vice versa.

The internal combustion engine is normally configured so that each piston performs an engine cycle during two crankshaft rotations, which corresponds to four strokes of the piston itself into the corresponding cylinder: intake stroke, compression stroke, expansion stroke and exhaust stroke. At the final stage of the compression stroke, fuel injector injects fuel directly into the combustion chamber to allow for the combustion phase.

In order to stabilize the combustion phase and reduce polluting emission for each engine cycle known control strategies monitor and regulate the injection of fuel in each cylinder of the engine using a combustion phasing control or closed-loop control of a parameter representative of the fuel combustion in the engine cylinders. One of the mostly used parameter in controlling the combustion phase is the MFB50 which is a parameter indicative of the crankshaft angular position at which the 50% of mass of the fuel injected into the cylinder has been burnt. The determination of the parameter requires an electronic control unit (ECU) to sample, using a combustion pressure sensor, the pressure value within the cylinder during an engine cycle so as to determine an in-cylinder pressure curve. The ECU then uses the in-cylinder pressure curve to calculate a heat release curve over the same engine cycle, and calculates the MFB50 on the basis of the heat release curve. Other combustion parameters indicative of the torque released during the engine cycles, such as the Indicated Mean Effective Pressure (IMEP), can also be determined on the basis of the in-cylinder pressure curve and used for feed-back controlling the injection phasing.

Given the way the signal is processed to obtain the required parameters any noise or spike on the measurements of pressure value via the combustion pressure sensors could strongly affect the torque and heat release computation as they might be confused as combustion events. Consequently combustion phasing control and closed-loop torque control could erroneously adjust combustion parameters (injected quantity, SOI, EGR rate) with a negative impact on emission, drivability and combustion noise.

It is therefore important to be able to identify if the pressure measurements obtained through the combustion pressure sensor are affected by noise in order to avoid the combustion to be erroneously controlled on erratic information.

Traditional noise detection methods are based on gradient analysis between two or more measured points. This methodology is quite ineffective for in-cylinder pressure curve which presents during the compression stage and the expansion stage an appreciable pressure gradient. In these cases a detection of a high gradient between two measurements of pressure values would not necessary be an indicator of the presence of a noise in the signal.

At least one object herein is therefore to provide a procedure to identify when measurements of pressure values in the combustion chambers are affected by noise.

Another object is to provide a method for identifying a noise in pressure measurements in a rational way without using complex devices and by taking advantage from the computational capabilities of the ECU of the vehicle. In addition, other objects, desirable features and characteristics will become apparent from the subsequent summary and detailed description, and the appended claims, taken in conjunction with the accompanying drawings and this background.

### SUMMARY

A method for operating an internal combustion engine wherein a noise in the in-cylinder pressure curve is identified is provided. According to an embodiment, a method for operating an internal combustion engine comprises:

measuring a plurality of values of pressure in a combustion chamber of the internal combustion engine during an engine cycle and a corresponding value of a crankshaft angular position for each of the measured pressure values;

selecting a group of the measured pressure values and the corresponding angular position values;

using the measured angular position values to calculate an inner volume value of the combustion chamber for each of the selected pressure values;

using each selected pressure values and relative determined volume value to calculate a value of a polytrophic constant according to the relationship C=pVk wherein C is the polytrophic constant, p is the pressure value, V is the volume value, and k is a polytrophic index;

calculating a root mean square deviation of the calculated polytrophic constant values; and

identifying that a noise has affected the pressure measurements if the calculated value of the root mean square deviation exceeds a threshold value thereof.

This solution allows for the identification of a pressure value measurement affected by noise and for proper recovery action to be taken.

According to another embodiment, the selected pressure values are measured during a compression phase of the engine cycle of the internal combustion engine. In this way it is possible to identify a noise in the pressure value measurements during the combustion phase wherein the gradient between consecutive pressure values is significantly high and traditional noise detecting methodologies based on gradient analysis are inadequate.

According to another embodiment, the selected pressure values are measured during an expansion phase of the engine cycle of the internal combustion engine. In this way it is possible to identify a noise in the pressure value measurements during the expansion phase wherein the gradient between consecutive pressure values is significantly high and traditional noise detecting methodologies based on gradient analysis are inadequate.

According to a further embodiment, the identification that a noise has affected the pressure measurements is used in a control strategy to operate the internal combustion engine. In this way it is possible to adjust a control strategy for operating the internal combustion engine that uses pressure value measurements by taking in consideration the presence of noise in the pressure measurements.

The methods can be carried out with the use of a computer program comprising a program-code for carrying out all the steps of the methods described above, and in the form of a computer program product comprising the computer program.

The computer program product can be embodied as an internal combustion engine equipped with a combustion pressure sensor and a crank position sensor and a ECU in communication with the combustion pressure sensor and the crank position sensor, a memory system associated with the ECU, and the computer program stored in the memory system, so that, when the ECU executes the computer program, all the steps of the method described above are carried out.

The method can be also embodied as an electromagnetic signal, the signal being modulated to carry a sequence of data bits which represents a computer program to carry out all steps of the method.

In an embodiment, a control apparatus for an internal combustion engine is equipped with a combustion pressure sensor and a crank position sensor, the control apparatus comprising an Electronic Control Unit in communication with the combustion pressure sensor and the crank position sensor, a memory system associated to the Electronic Control Unit and a computer program stored in the memory system.

In another embodiment, an automotive system includes an internal combustion engine equipped with a combustion pressure sensor and a crank position sensor, the automotive system also comprising an Electronic Control Unit in communication with the combustion pressure sensor and the crank position sensor, a memory system associated with the Electronic Control Unit and a computer program stored in the memory system.

### BRIEF DESCRIPTION OF THE DRAWINGS

The various embodiments will hereinafter be described in conjunction with the following drawing figures, wherein like numerals denote like elements, and wherein:

FIGS. 1 and 2 are schematic representations of an automotive system comprising an internal combustion engine;

FIG. 3 shows a pressure/crank-angle diagram, which represents an in-cylinder pressure curve within a cylinder of an internal combustion engine during an engine cycle; and

FIG. 4 is a schematic representation of the steps of an aspect of an embodiment of the method disclosed.

### DETAILED DESCRIPTION

The following detailed description is merely exemplary in nature and is not intended to limit the various embodiments or the application and uses thereof. Furthermore, there is no intention to be bound by any theory presented in the preceding background or the following detailed description.

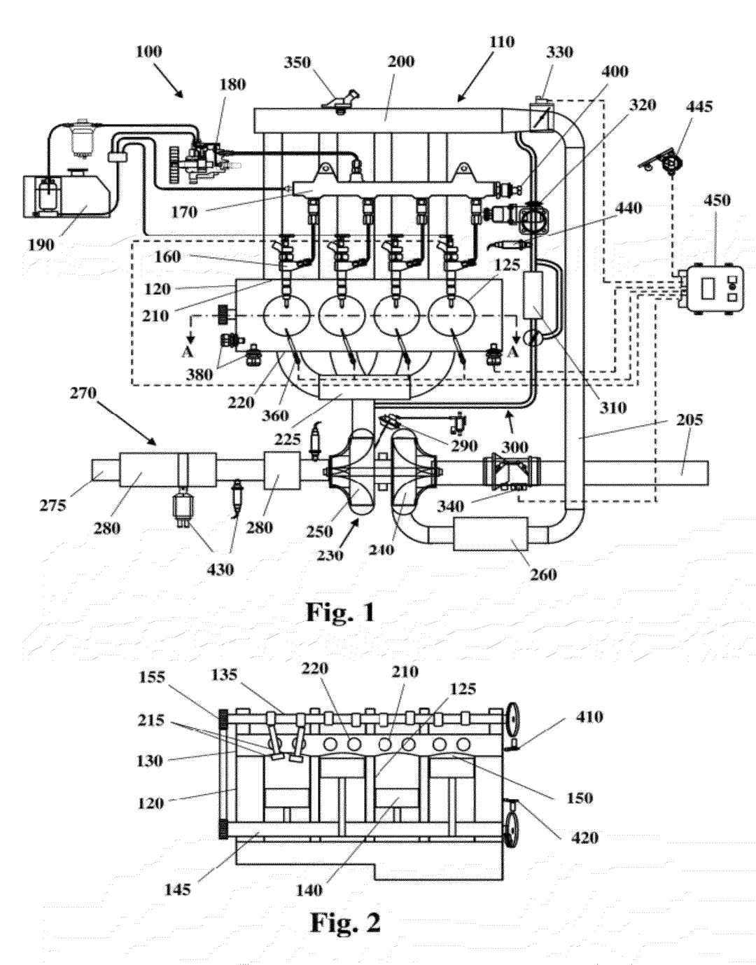

The various embodiments are hereinafter disclosed with reference to a four-cylinder four-stroke Diesel engine. Some embodiments may include an automotive system 100, as shown in FIGS. 1 and 2, that includes an internal combustion engine (ICE) 110 having an engine block 120 defining at least one cylinder 125 having a piston 140 coupled to rotate a crankshaft 145. A cylinder head 130 cooperates with the piston 140 to define a combustion chamber 150. A fuel and air mixture (not shown) is disposed in the combustion chamber 150 and ignited, resulting in hot expanding exhaust gasses causing reciprocal movement of the piston 140. The fuel is provided by at least one fuel injector 160 and the air through at least one intake port 210. The fuel is provided at high pressure to the fuel injector 160 from a fuel rail 170 in fluid communication with a high pressure fuel pump 180 that increase the pressure of the fuel received a fuel source 190. Each of the cylinders 125 has at least two valves 215, actuated by a camshaft 135 rotating in time with the crankshaft 145. The valves 215 selectively allow air into the combustion chamber 150 from the port 210 and alternately allow exhaust gases to exit through a port 220. In some examples, a cam phaser 155 may selectively vary the timing between the camshaft 135 and the crankshaft 145.

The air may be distributed to the air intake port(s) 210 through an intake manifold 200. An air intake duct 205 may provide air from the ambient environment to the intake manifold 200. In other embodiments, a throttle body 330 may be provided to regulate the flow of air into the manifold 200. In still other embodiments, a forced air system such as a turbocharger 230, having a compressor 240 rotationally coupled to a turbine 250, may be provided. Rotation of the compressor 240 increases the pressure and temperature of the air in the duct 205 and manifold 200. An intercooler 260 disposed in the duct 205 may reduce the temperature of the air. The turbine 250 rotates by receiving exhaust gases from an exhaust manifold 225 that directs exhaust gases from the exhaust ports 220 and through a series of vanes prior to expansion through the turbine 250. The exhaust gases exit the turbine 250 and are directed into an exhaust system 270. This example shows a variable geometry turbine (VGT) with a VGT actuator 290 arranged to move the vanes to alter the flow of the exhaust gases through the turbine 250. In other embodiments, the turbocharger 230 may be fixed geometry and/or include a waste gate.

The exhaust system 270 may include an exhaust pipe 275 having one or more exhaust after-treatment devices 280. The after-treatment devices may be any device configured to change the composition of the exhaust gases. Some examples of after-treatment devices 280 include, but are not limited to, catalytic converters (two and three way), oxidation catalysts, lean NOx traps, hydrocarbon adsorbers, selective catalytic reduction (SCR) systems, and diesel particulate filters. Other embodiments may include an exhaust gas recirculation (EGR) system 300 coupled between the exhaust manifold 225 and the intake manifold 200. The EGR system 300 may include an EGR cooler 310 to reduce the temperature of the exhaust gases in the EGR system 300. An EGR valve 320 regulates a flow of exhaust gases in the EGR system 300.

The automotive system 100 may further include an electronic control unit (ECU) 450 in communication with one or more sensors and/or devices associated with the ICE 110. The ECU 450 may receive input signals from various sensors configured to generate the signals in proportion to various physical parameters associated with the ICE 110. The sensors include, but are not limited to, a mass airflow and temperature sensor 340, a manifold pressure and temperature sensor 350, a combustion pressure sensor 360, coolant and oil temperature and level sensors 380, a fuel rail pressure sensor 400, a cam position sensor 410, exhaust pressure and temperature sensors 430, an EGR temperature sensor 440, and an accelerator pedal position sensor 445.

The internal combustion engine is equipped with a crankshaft angular position sensor 420, which schematically comprises a wheel coaxially fixed to the crankshaft and a stationary electric component cooperating with the crankshaft wheel, wherein the crankshaft wheel and the stationary electric component are designed so that each possible angular position of the crankshaft wheel causes the electric component to generate a corresponding electric signal, which is sent to the ECU 450.

Furthermore, the ECU 450 may generate output signals to various control devices that are arranged to control the operation of the ICE 110, including, but not limited to, the fuel injectors 160, the throttle body 330, the EGR Valve 320, the VGT actuator 290, and the cam phaser 155. Note, dashed lines are used to indicate communication between the ECU 450 and the various sensors and devices, but some are omitted for clarity.

Turning now to the ECU 450, this apparatus may include a digital central processing unit (CPU) in communication with a memory system and an interface bus. The CPU is configured to execute instructions stored as a program in the memory system, and send and receive signals to/from the interface bus. The memory system may include various storage types including optical storage, magnetic storage, solid state storage, and other non-volatile memory. The interface bus may be configured to send, receive, and modulate analog and/or digital signals to/from the various sensors and control devices. The program may embody the methods disclosed herein, allowing the CPU to carryout out the steps of such methods and control the ICE 110.

The method for operating an internal combustion engine 110 according to an embodiment will now be described more in details with reference to FIG. 4. It is known that the pressure inside the cylinders 125 follows a substantially defined trend during an engine cycle. In particular the pressure value in the cylinder 125 remains substantially constant around a low value during the intake stroke; rises rapidly during the compression stroke, after the valve(s) 215 are closed; has a peak when the piston 140 is nearest the top of the cylinder (Top Dead Center or TDC) due to fuel combustion in the combustion chamber; decreases rapidly during the expansion stroke and, after the opening of valve(s) 215, remains substantially constant around a low value during the whole exhaust stroke.

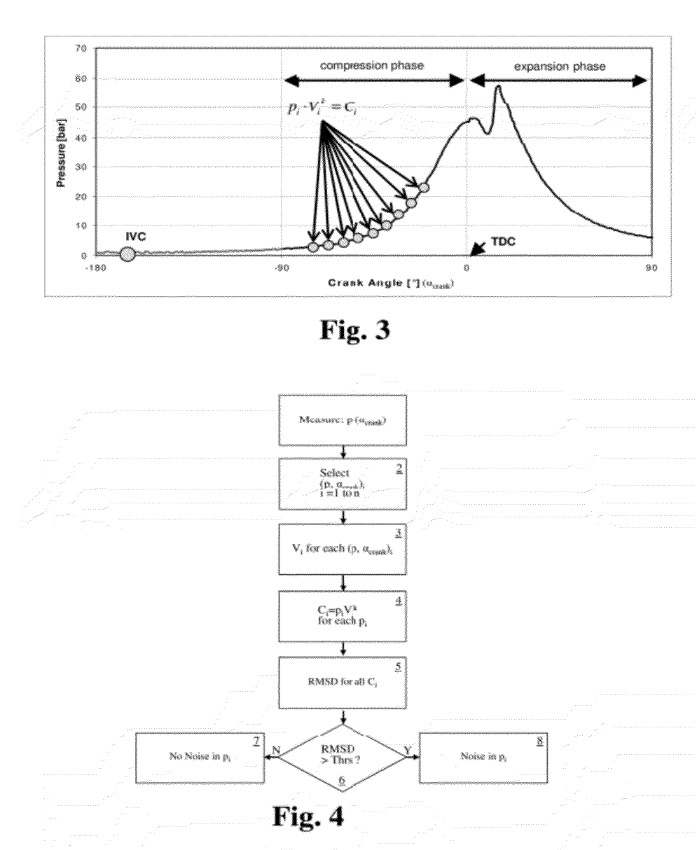

This in-cylinder pressure curve, i.e. the curve of the pressure value over the crankshaft angular position, shown in FIG. 3, recurs cyclically every two crankshaft rotations, maintaining substantially the same trend but varying in response to variations of engine operating parameters, such as for example engine speed, engine load, start of injection, EGR ratio, etc.

In an embodiment, the in-cylinder pressure curve is obtained, block 1, by measuring a plurality of values of pressure p within the combustion chamber and the corresponding values of crankshaft angular position, acrank, for each of the measured pressure values.

The pressure values are measured by dedicated combustion pressure sensors 360 located in each cylinder 125, and integrated in the glow plug associated to the cylinder 125 itself and connected to the ECU 450 via an analog/digital converter, in an exemplary embodiment.

The crankshaft angular position values are measured by the crankshaft angular position sensor 420.

During the compression phase and the expansion phase it can be assumed that there is no heat exchange, neither positive, during combustion, nor negative, as the exchange of heat through the walls of the combustion chamber is considered to be insignificant. Consequently, given the adiabatic condition of the combustion chamber, a polytrophic model is applicable during such phases.

According to the polytrophic model:

PV^{k}=C (1)

wherein p is the pressure value in the combustion chamber 150, V is the inner volume value of the combustion chamber 150, k is the polytrophic index and C is a polytrophic constant.

According to an embodiment, the method provides for selecting a plurality of pressure values and corresponding crankshaft angular position values which have been measured during the compression phase or during the expansion phase, block 2, i.e. when the polytrophic model is applicable. In order to apply equation (1) the inner volume value V of the combustion chamber 150 for each pressure value needs to be calculated. This can be achieved by using the measured crankshaft angular position values. In fact the inner volume of a combustion chamber 150 is linked to the position of the piston 140 which is itself linked to the angular position value αcrank of the crankshaft 145. Therefore, once the angular position value αcrank is known, the corresponding inner volume V can be easily derived.

At this point equation (1) can be used to calculate a constant value C for each selected measured pressure value p and relative inner volume value V, block 4. If the pressure measurements among the selected points are not affected by noise the calculated polytrophic constant C remains practically the same for all the selected points. If the pressure measurements are affected by noise, the value of the polytrophic constant C calculated for two points may be different.

According to an embodiment, the method provides for a way to identify that a noise has affected the pressure measurements by calculating the root mean square deviation (RMSD) of the calculated polytrophic constant values C, block 5, and comparing it to a RMSD threshold value, block 6. The RMSD threshold value can be set during a calibration phase. If the calculated RMSD is below or equal to the predetermined RMSD threshold value, block 7, it can be inferred that the selected pressure measurements are not affected by noise. On the other hand, if the calculated RMSD is above the predetermined RMSD threshold value, block 8, it can be inferred that the selected pressure measurements are affected by noise. By detecting the presence of a noise it is possible to improve the noise rejection on combustion control, for example a single spike can be ignored or even compensated with no impact on combustion control. Also the diagnosis on combustion pressure sensors can be improved since a signal affected by noise can be identified and an appropriate recovery action can be taken. Finally a noisy signal can be distinguished from other failures of the combustion pressure sensor 360 and the service can be addressed to the appropriate service procedure (i.e. connector and wiring checks).

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment, it being understood that various changes may be made in the function and arrangement of elements described in an exemplary embodiment without departing from the scope of the invention as set forth in the appended claims and their legal equivalents.

What is claimed is:

1. A method for operating an internal combustion engine, the method comprising the steps of:
measuring a plurality of values of pressure in a combustion chamber of the internal combustion engine during an engine cycle and a corresponding value of crankshaft angular position for each of plurality of values of pressure;
selecting a group of values from the plurality of values of pressure and the corresponding value of crankshaft angular position for each value of the group of values from the plurality of values of pressure;
using the corresponding values of crankshaft angular position to calculate a corresponding inner volume value of the combustion chamber for each of the group of values from the plurality of values of pressure;
calculating, for each of the group of values from the plurality of values of pressure and the corresponding inner volume value, a value of a polytrophic constant according to a relationship C=pV^{k} wherein C is the polytrophic constant, p is a value of pressure, V is a corresponding inner volume value, and k is a polytrophic index;
calculating a root mean square deviation of the values of the polytrophic constant; and
identifying that a noise has affected the plurality of values of pressure if root mean square deviations exceed a threshold value thereof.

2. A method according to claim 1, wherein the plurality of values of pressure are measured during a compression phase of the engine cycle of the internal combustion engine.

3. A method according to claim 1, wherein the plurality of values of pressure are measured during an expansion phase of the engine cycle of the internal combustion engine.

4. A method according to claim 1, wherein the identifying that the noise has affected the plurality of values of pressure is used in a control strategy to operate the internal combustion engine.

5. An internal combustion engine comprising a combustion chamber defined by a piston reciprocating within a cylinder and coupled to rotate a crankshaft, a combustion pressure sensor within the combustion chamber and a crank position sensor, the internal combustion engine also comprising an electronic control unit in communication with the combustion pressure sensor and the crank position sensor, the electronic control unit configured for:
measuring a plurality of values of pressure in the combustion chamber during an engine cycle and a corresponding value of crankshaft angular position for each of the plurality of values of pressure;
selecting a group of values from the plurality of values of pressure and the corresponding value of crankshaft angular position for each value of the group of values from the plurality of values of pressure;
using the corresponding values of crankshaft angular position to calculate a corresponding inner volume value of the combustion chamber for each of the group of values from the plurality of values of pressure;
calculating, for each of the group of values from the plurality of values of pressure and the corresponding inner volume value, a value of a polytrophic constant according to a relationship C=pV^{k} wherein C is the polytrophic constant, p is a value of pressure, V is a corresponding inner volume value, and k is a polytrophic index;
calculating a root mean square deviation of the values of the polytrophic constant; and
identifying that a noise has affected the plurality of values of pressure if root mean square deviations exceed a threshold value thereof.

6. The internal combustion engine according to claim 5, wherein the electronic control unit is further configured for measuring the plurality of values of pressure during a compression phase of the engine cycle of the internal combustion engine.

7. The internal combustion engine according to claim 5, wherein the electronic control unit is further configured for measuring the plurality of values of pressure during an expansion phase of the engine cycle of the internal combustion engine.

8. The internal combustion engine according to claim 5, wherein the identifying that the noise has affected the plurality of values of pressure is used in a control strategy to operate the internal combustion engine.

9. The internal combustion engine according to claim 5, wherein the electronic control unit further comprises a computer program product comprising a computer program, the computer program configured to:
measure the plurality of values of pressure in the combustion chamber during the engine cycle and the corresponding value of crankshaft angular position for each of plurality of values of pressure;
select the group of values from the plurality of values of pressure and the corresponding value of crankshaft angular position for each value of the group of values from the plurality of values of pressure;
use the corresponding values of crankshaft angular position to calculate the corresponding inner volume value of the combustion chamber for each of the group of values from the plurality of values of pressure;
calculate, for each of the group of values from the plurality of values of pressure and the corresponding inner volume value, the value of the polytrophic constant according to the relationship C=pV^{k} wherein C is the polytrophic constant, p is the value of pressure, V is the corresponding inner volume value, and k is the polytrophic index;
calculate the root mean square deviation of the values of the polytrophic constant; and
identify that the noise has affected the plurality of values of pressure if the root mean square deviations exceed the threshold value thereof.

10. An automotive system having an internal combustion engine comprising a combustion chamber defined by a piston reciprocating within a cylinder and coupled to rotate a crankshaft, a combustion pressure sensor within the combustion chamber and a crank position sensor, the automotive system also comprising an electronic control unit in communication with the combustion pressure sensor and the crank position sensor, the electronic control unit configured for:
measuring a plurality of values of pressure in the combustion chamber during an engine cycle and a corresponding value of crankshaft angular position for each of plurality of values of pressure;
selecting a group of values from the plurality of values of pressure and the corresponding value of crankshaft angular position for each value of the group of values from the plurality of values of pressure;
using the corresponding values of crankshaft angular position to calculate a corresponding inner volume value of the combustion chamber for each of the group of values from the plurality of values of pressure;
calculating, for each of the group of values from the plurality of values of pressure and the corresponding inner volume value, a value of a polytrophic constant according to a relationship C=pV^{k} wherein C is the polytrophic constant, p is a value of pressure, V is a corresponding inner volume value, and k is a polytrophic index;
calculating a root mean square deviation of the values of the polytrophic constant; and
identifying that a noise has affected the plurality of values of pressure if root mean square deviations exceed a threshold value thereof.

11. The automotive system according to claim 10, wherein the electronic control unit is further configured for measuring the plurality of values of pressure during a compression phase of the engine cycle of the internal combustion engine.

12. The automotive system according to claim 10, wherein the electronic control unit is further configured for measuring the plurality of values of pressure during an expansion phase of the engine cycle of the internal combustion engine.

13. The automotive system according to claim 10, wherein the identifying that the noise has affected the plurality of values of pressure is used in a control strategy to operate the internal combustion engine.
